(19) United States
(12) Patent Application Publication
(10) Pub. No.: US 2020/0116481 A1
(43) Pub. Date: Apr. 16, 2020

(54) GOLF VOICE BROADCAST RANGEFINDER

(71) Applicant: TUNG SHRIM ENTERPRISE CO., LTD., Taichung City (TW)

(72) Inventor: Wen-I Chang, Taichung City (TW)

(21) Appl. No.: 16/395,260

(22) Filed: Apr. 26, 2019

(30) Foreign Application Priority Data
Oct. 16, 2018 (TW) 107213991

(51) Int. Cl. G01C 3/02; G08B 7/06; A63B 71/06

(52) U.S. Cl. CPC G01C 3/02; G08B 7/06; A63B 2102/32; A63B 2071/0625; A63B 71/0622

(57) ABSTRACT

A golf voice broadcast rangefinder comprises a shell-body, which front end is respectively set with at least one lenses and a sensing window, and a monitor displaying the picture of the lenses is set at its rear end; and a distance-sensing unit is set inside; wherein the distance-sensing unit comprises first sensors and second sensors, an operation processor, a memory, and a voice-output module; wherein the first sensors and second sensors respectively scans at least one first target and a plurality of second targets, and the operation processor calculates the distances of the first target and each of the second targets; wherein the distance data of the first target and each of the second targets are respectively displayed on the monitor; and the voice-output module respectively outputs the distance data using voice; by this, the distances can be clearly seen to formulate a hitting strategy.

### TECHNICAL FIELD OF THE INVENTION

The present invention relates to a distance measuring device, and especially relates to a golf voice broadcast rangefinder having a monitor and capable of simultaneously scanning and detecting a plurality of targets, and capable of further measuring a distance between a first target and a plurality of second targets.

### DESCRIPTION OF THE RELATED ART

Generally, the rules of golf are mainly to require the competitor to enter the target (i.e. the Green) hole from the tee shot with the least number of strokes, and the two basic elements between the tee shot and the target hole are “distance” and “angle” (of course, there are other factors such as wind speed and turf direction, etc., which will not be further described here).

In addition to controlling the direction of the ball with the swing skill of the competitor, the most important thing is that the distance of the target place must be accurately measured by his experience in order to control the hitting distance.

For beginners in golf, in addition to having to constantly practice swinging to improve ball control and swing strength, the most important thing is to learn how to accurately detect the distance between the target place and the swing location. The conventional distance measuring device has the disadvantage that it can only detect the distance of a single target. For the user, if it is necessary to detect the distance of another target, it needs to be measured in another time, which is not convenient; furthermore, the measurements of different times still needs to record the distance data of each target using paper and pen.

In addition, the conventional range finder needs to be placed in front of the eyes and to observe through the lenses; the disadvantage is that the picture is small and is inconvenient to use; so the conventional distance measuring device still has the necessity to be improved.

### SUMMARY OF THE INVENTION

In view of the above-mentioned defects, the golf voice broadcast rangefinder of the present invention comprises: a shell-body, wherein the front end of the shell-body is respectively set with at least one lenses and a sensing window;

wherein a monitor is set at the rear end of the shell-body, and the picture of the lenses is displayed by the monitor; and a distance-sensing unit set inside the shell-body and corresponding to the sensing window; wherein the distance-sensing unit comprises a plurality of first sensors, a plurality of second sensors, an operation processor, a memory, and a voice-output module; wherein each of the first sensors and each of the second sensors respectively scans at least one first target and a plurality of second targets, and the operation processor calculates the distances of the first target and each of the second targets; wherein the distance data of the first target and the distance data of each of the second targets are respectively displayed on the monitor; and the voice-output module respectively outputs the distance data of the first target and the distance data of each of the second targets using voice; by this, the golf voice broadcast rangefinder of the present invention is more convenient to use; and the distances of the first target and each of the surrounding second targets can be clearly seen through the monitor to formulate a hitting strategy.

### BRIEF DESCRIPTION OF THE DRAWINGS

FIG. 1 is a stereoscopic appearance diagram of the present invention.

FIG. 2 is a stereoscopic appearance diagram of another perspective continuing FIG. 1.

FIG. 3 is a structure schematic diagram of the distance-sensing unit of the present invention.

FIG. 4 is a picture schematic diagram of the monitor of the present invention.

FIG. 5 is a schematic diagram of the distance data continuing FIG. 3.

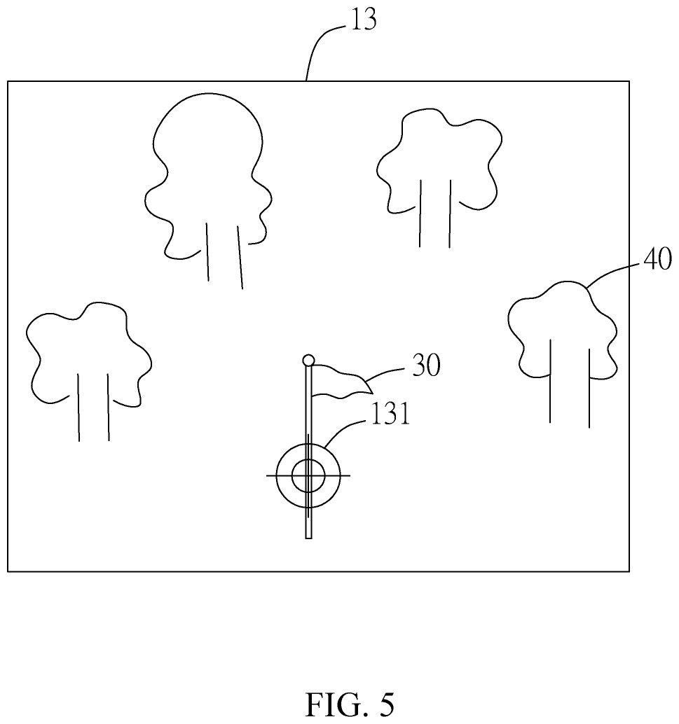

FIG. 6 is a schematic diagram of the distance data of another mode of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

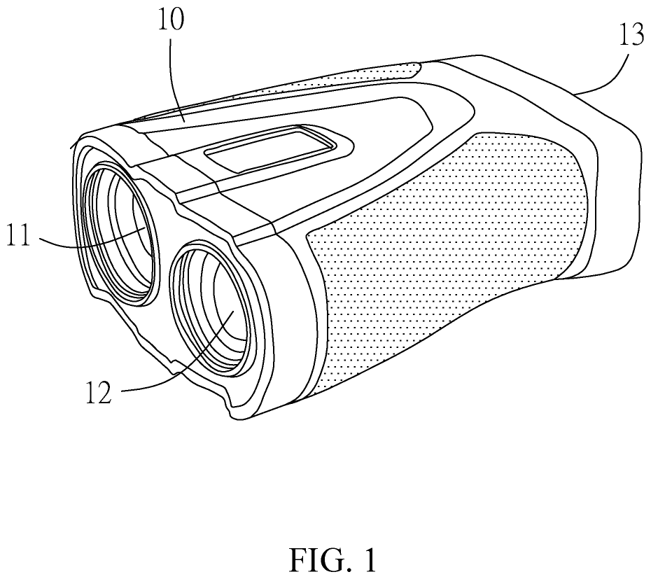

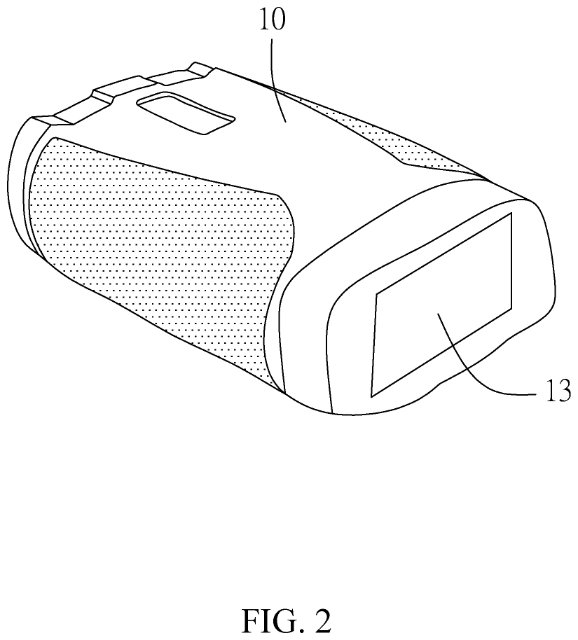

Please refer to FIG. 1 to FIG. 3, the golf voice broadcast rangefinder of the present invention comprises: a shell-body 10 and a distance-sensing unit 20; wherein the front end of the shell-body 10 is respectively set with a lenses 11 and a sensing window 12; wherein a monitor 13 is set at the rear end of the shell-body 10, and the lenses 11 is connected with the monitor 13; wherein the lenses 11 has the optical zoom and digital zoom functions, and a crosshair 131 is further displayed on the monitor 13; wherein the picture of the lenses 11 is displayed by the monitor 13.

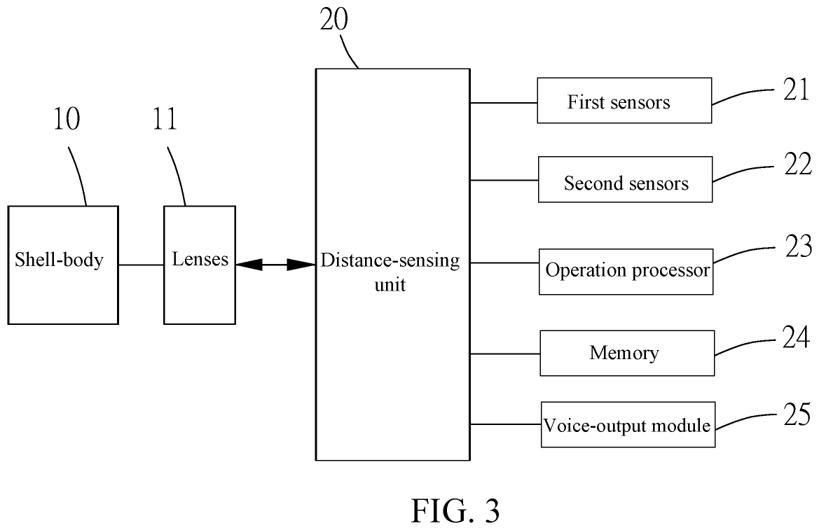

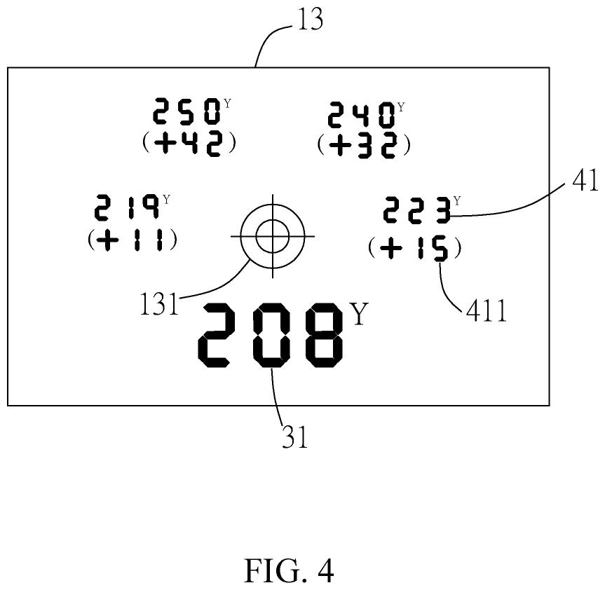

Please refer to FIG. 3 and FIG. 4, the distance-sensing unit 20 is set inside the shell-body 10 and is electrically connected with the lenses 11; wherein the distance-sensing unit 20 is corresponding to the sensing window 12; wherein the distance-sensing unit 20 comprises a plurality of first sensors 21, a plurality of second sensors 22, an operation processor 23, a memory 24, and a voice-output module 25; wherein the voice-output module 25 comprises at least one speaker (not shown in the figures), and each of the first sensors 21 and each of the second sensors 22 are a multi-axis sensor.

For the using way of the golf voice broadcast rangefinder of the present invention, please refer to FIG. 3 and FIG. 4; the lenses 11 faces the first target 30 and each of the second targets 40, and the user views the first target 30 and each of the second targets 40 through the monitor 13; in this embodiment, the first target 30 is a flagpole and each of the second targets 40 is a forest tree behind or around the flagpole; which each of the first sensors 21 and each of the second sensors 22 respectively and reciprocally scans from top to bottom and from left to right at least one first target 30 and a plurality of second targets 40; wherein the crosshair 131 is provided to target the first target 30, and the distance data 31 of the first target 30 is adjacent to the crosshair 131.

The distances of the first target 30 and each of the second targets 40 are calculated by the operation processor 23; and the distance data 31 of the first target 30 and the distance data 41 of each of the second targets 40 are respectively displayed on the monitor 13; and the voice-output module 25 respectively outputs the distance data 31 of the first target 30 and the distance data 41 of each of the second targets 40 using voice.

At the same time, the distance data 31 of the first target 30 and the distance data 41 of each of the second targets 40 are stored in the memory 24; so that the user can re-view the previous detected distance data 31, 41 without needing to repeatedly scan and detect.

In addition, the distance between the first target 30 and each of the second targets 40 is sequentially displayed from near to far; in short, after the scanning and calculating by the distance-sensing unit 20, only the closest distance data 41 of the second targets 40 near the first target 30 is displayed; in this embodiment, the number of the second targets 40 is 4, and the distance data 41 of each of the second targets 40 is located at the outside of the crosshair 131 and at the outside of the distance data 31 of the first target 30; and which is consistent with the position of each of the second targets 40.

By the operation function of the operation processor 23, a secondary important distance data 411 is respectively displayed below the distance data 41 of each of the second targets 40; and the secondary important distance data 411 is respectively the distance of the first target 30 to each of the second targets 40.

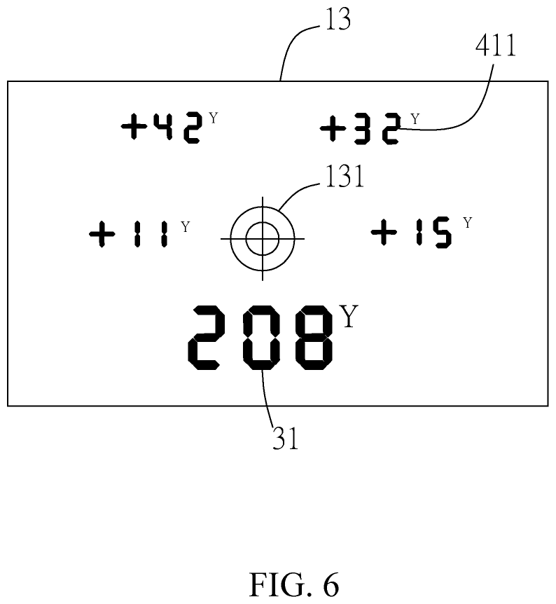

Please refer to FIG. 6, the user can also change the setting; so that the monitor 13 only displays the distance data 31 of the first target 30 and the secondary important distance data 411 of each of the second targets 40, so as to be more in line with the user's reading habit of the observed data.

I claim:

1. A golf voice broadcast rangefinder, which comprises:
a shell-body, wherein the front end of the shell-body is respectively set with at least one lenses and a sensing window; wherein a monitor is set at the rear end of the shell-body, and the picture of the lenses is displayed by the monitor; and
a distance-sensing unit set inside the shell-body and electrically connected with the lenses; wherein the distance-sensing unit is corresponding to the sensing window;
wherein the distance-sensing unit comprises a plurality of first sensors, a plurality of second sensors, an operation processor, a memory, and a voice-output module; wherein each of the first sensors and each of the second sensors respectively and reciprocally scans from top to bottom and from left to right at least one first target and a plurality of second targets, wherein the distances of the first target and each of the second targets are calculated by the operation processor, and the distance data of the first target and the distance data of each of the second targets are respectively displayed on the monitor;
wherein the voice-output module respectively outputs the distance data of the first target and the distance data of each of the second targets using voice; at the same time, the distance data of the first target and the distance data of each of the second targets are stored in the memory; and the distance between the first target and each of the second targets is sequentially displayed from near to far.

2. The golf voice broadcast rangefinder according to claim 1, wherein each of the first sensors and each of the second sensors are a multi-axis sensor.

3. The golf voice broadcast rangefinder according to claim 1, wherein a crosshair is further displayed on the monitor, and the crosshair is provided to target the first target, and the distance data of the first target is adjacent to the crosshair.

4. The golf voice broadcast rangefinder according to claim 3, wherein the distance data of each of the second targets is located at the outside of the crosshair and at the outside of the distance data of the first target.

5. The golf voice broadcast rangefinder according to claim 4, wherein a secondary important distance data is respectively displayed below the distance data of each of the second targets; and the secondary important distance data is respectively the distance of the first target to each of the second targets.
